(19) United States
(12) Patent Application Publication
(10) Pub. No.: US 2001/0007972 A1
(43) Pub. Date: Jul. 12, 2001

(54) Method and apparatus for verifying adequacy of test patterns

(76) Inventors: Hiroshi Araki, Tokyo (JP); Yasunori Okamoto, Tokyo (JP)

Correspondence Address: GALLAGHER & LATHROP, Suite 1111, 60 California Street, San Francisco, CA, 94108-2805, US

(21) Appl. No.: 09/754,171

(22) Filed: Jan. 3, 2001

(30) Foreign Application Priority Data
Jan. 7, 2000 (JP) 001270/00

(51) Int. Cl. G06F 9/455

(52) U.S. Cl. 703/16

(57) ABSTRACT

A test pattern which is delivered from an LSI tester simulator and a corresponding test cycle number are stored in a first memory 26 while device output data which is formed by CAD data and a corresponding test time are stored in a second memory 27. The test pattern in the first memory and the device output data in the corresponding second memory are extracted by a comparing and synchronizing unit 28 and are then input to the LSI tester simulator 10. In the LSI tester simulator, the device output data is compared against expected values. If the entire device output data are in coincidence with the expected values, this test pattern is determined to be acceptable. In addition, a verification is made to see whether or not a strobe pulse which defines the determination timing for the comparison between the device output data and the expected values has occurred for all the states in the device output data.

### BACKGROUND OF THE INVENTION

The present invention relates to a verifier for test patterns which are used for testing a semiconductor integrated circuit (hereafter simply referred to as “device”) such as VLSI, and in particular, to a test pattern verifying method of rapidly verifying the acceptability or fault of test patterns which are prepared for a semiconductor tester on the basis of logic simulation data formulated during a design stage by CAD (computer aided design) technique of a device and performing a simulative fault diagnosis of a device, without using an actual semiconductor tester or device under test, and a rapid test pattern adequacy verifying apparatus which employs the method.

A step of developing a device such as VLSI generally employs a computer aided design (CDA) technique. During such development step with CAD, an intended LSI circuit is designed in the device using hardware description language such as VHDL or Verilog, and the operation of the designed circuit is verified on a computer by a simulator which is implemented by a software referred to as “device logic simulator”.

The device logic simulator is provided with an interface which is referred to as “test bench”, through which testing data (test vectors) is simulatively applied to the device in order to test the design data (CAD data) of the intended device and to produce the device response simulatively. A pseudo response output which is thus produced simulatively is compared against an expected value which is produced simulatively in order to verify the acceptability or fault.

When a device is actually manufactured after such a development step, various functions of the device are actually tested using a tester which is commonly referred to as “LSI tester”. The LSI tester applies a test pattern (test vectors) to the device under test, and compares a resulting output signal from the device against a given expected value to determine the acceptability or fault of the device. It will be noted that the testing of the device with the LSI tester has a close similarity to the described verification by the device logic simulator during the CAD device design stage.

Accordingly, it follows that steps of preparing a program to generate a test pattern and a program to generate a pattern of expected values, both required for testing the device, could be omitted if data obtained when the device logic simulator is driven during the device design step were utilized for testing devices which are actually manufactured. This would result in enhancing a production efficiency of the testing program. Thus, a test pattern which is adapted to the LSI tester testing the device under test and a pattern of expected values could be obtained from data (dump file) which is acquired as a result of execution of the logic simulation.

In the logic simulation, a test pattern that is applied to a pseudo semiconductor integrated circuit (hereafter referred to as “device model”), pseudo response output data that is to be delivered from the device model, and a pattern of expected values which are used in the comparison with the response output data to determine the acceptability or fault are all denoted on the event basis.

The term “event basis” refers to the fact that data is in the form of a time sequence of transitions (events) of the test pattern from logic “1” to logic “0” or vice versa. The time sequence is defined either in the form of a continuous or absolute time passed from a certain reference, for example, which may be a start of the test or a length of time passed since an immediately preceding event.

FIG. 1 illustrates an example of describing event basis data. FIG. 2 schematically illustrates the event basis data in the form of waveforms. Here, examples are given for the logic of a test pattern applied to individual pins P1, P2, P3 . . . of the device model and the logic of outputs from the device model at times where events occurs since a reference timing. Specifically, in FIG. 1, logic (either 0 or 1) at pins P1, P2, P3 . . . at times 5 ns, 10 ns, 15 ns . . . when events occur are described. In FIG. 2, there is shown a clock train representing a time sequence, and waveforms indicating a change in the logic are shown in FIGS. 2B, 2C . . . in a manner corresponding to respective timings in the clock train.

By contrast, in the actual LSI tester, a test pattern is generally represented on the cycle basis. The term “cycle basis” means that a serial number is allocated to each test cycle as an address and that for each address, an initial timing of the test cycle is defined as an initial phase and a time passed since the initial phase is used as timing data to describe the start and the end of a test pattern signal. FIG. 3 shows an example of describing the cycle basis data. For each test cycle (address), the logic values of test pattern signals applied to respective pins P1, P2, P3 . . . of an LSI under test as well as the start timing T1 and the end timing T2 as referenced to the initial phase of the test cycle are defined. For example, for test cycle No. 1, a test pattern for the pin 1 is described as the logic value H (=1) beginning at T1=5 sn and ending at T2=10 ns.

FIG. 4 shows a relationship between the logic value TP of the test pattern and the timing data T1 and T2 for each pin of the device which prevails in the LSI tester during each test cycle. For example, FIG. 4A shows, for the pin 1, the T1 timing on the upper line, the T2 timing on the middle line and the test pattern waveform on the lower line. FIG. 4 also schematically shows an example of the cycle basis data which is shown in FIG. 3 in the form of a waveform. The start and the end of the test pattern signals which are applied to the pins P1, P2, P3 . . . of LSI under test are defined by the timing data T1 and T2 as shown in FIG. 4.

A difference between the event basis data and the cycle basis data will have been recognized from the foregoing description, and it is to be noted that by utilizing CAD data which are produced during the development design of LSI under test, a test pattern and a pattern of expected values which are required to an actual testing of devices under test which are actually manufactured can be efficiently prepared. In practice, however, due to the difference in data format between the event basis data and the cycle basis data, there are instances that the test pattern and the pattern of expected values which are produced for the LSI tester cannot be desired patterns which enable faults in the devices under test to be properly detected. As a consequence, there is a need to verify the adequacy of test patterns which are produced by the described procedure.

In the prior art practice, when verifying the test pattern and the pattern of expected values which are derived from the logic simulation data to be used with the LSI tester, there are two procedures, one using and the other not using the actual LSI tester. According to the procedure which uses the actual LSI tester, the test pattern in the event basis format during the logic simulation must be extracted and converted into the test pattern in the cycle basis format. Using the test pattern which is converted into the cycle basis of format, the actual LSI tester is used in verifying the adequacy of the test pattern. With this procedure, there is a difficulty in that the expensive LSI tester is occupied exclusively for the verification of the test pattern.

On the other hand, according to the other procedure which does not use the actual LSI tester, the function of the actual LSI tester is served by an LSI tester simulator which is formed in software. Again, the adequacy of the test pattern which is converted from the event basis format into the cycle basis format is verified (or debugged). In this instance, in order for the LSI tester simulator to simulate the operation of the device in response to the test pattern, the logic simulator (device model) which is obtained during the CAD design stage will be used. A software processing of all of these operations has a disadvantage that it takes a very long processing time.

A method of verifying the adequacy of a test pattern according to the prior art which does not use the actual LSI tester will be described with reference to FIG. 5. In this instance, an LSI tester simulator 10 and a pseudo device formed by a logic simulator 22 are used, and all the operation takes place by a software operation. Thus, FIG. 5 shows the functional arrangement of an apparatus 100 for verifying the adequacy of a test pattern.

The apparatus for verifying the adequacy of a test pattern 100 comprises an LSI tester simulator 10, a pseudo device 20, and a data source 30, all of which are principally implemented in software. The LSI tester simulator 10 executes the operation of debugging the test pattern or the device itself without using the LSI tester as the hardware. Accordingly, the pattern data which is converted into the cycle basis format and the timing data are downloaded from a pattern file storage 32 and a timing file storage 33 in the data source 30 into the LSI tester simulator 10. A test pattern including timing data and a pattern of expected values are produced by the LSI tester simulator 10 from the pattern data and the timing data which are downloaded into the LSI test simulator 10. The test pattern produced is applied to the pseudo device 20 in the sequence of tests to be performed.

The pseudo device 20 comprises a format converter 21, a logic simulator 22, a device model 23, a format converter 24 and a dump file storage 25. The format converter 21 converts a test pattern which is input from the LSI test simulator 10 into the event basis data, which is then input to the logic simulator 22.

During the design of the device, the logic simulator 22 is used to input data into the device model 23 to operate it, thereby producing a resulting device output data. This device output data, the input data as well as the event time as referenced to the start of the test are stored in the dump file storage 25. When the test pattern is input from the format converter 21 into the logic simulator 22, the latter applies the pattern to the device model 23 to obtain the resulting response output from the device model 23.

This device model response output data is delivered from the logic simulator 22 to the format converter 24 where it is converted from the event basis format into the cycle basis format, which is in turn input to the LSI tester simulator 10 as the output data from the pseudo device 20. The LSI tester simulator 10 compares the device output data from the pseudo device 20 against an expected value which it has produced itself to see coincidence or non-coincidence. In the event of a non-coincidence, it is determined that the test pattern applied to the pseudo device 20 contains a fault.

It will be seen that the data source 30 comprises a conversion software 31, a pattern file storage 32 and a timing file storage 33. Dump file, namely, the time of each event and input data, in the event basis format are downloaded from the dump file storage 25 into the conversion software 31 where the dump file is converted into cycle basis pattern data and timing data. The pattern data or H or L of each TP shown in FIG. 3, for example, is stored in the pattern file storage 32 while the timing data, for example, T1 value and T2 value shown in FIG. 3, are stored in the timing file storage 33 for each event (test cycle). The pattern file storage 32 and the timing file storage 33 are thus provided to be read into the LSI tester simulator 10.

When the LSI tester simulator 10, the logic simulator 22 and the device model 23 are used to process all the operations in a software, each time a test pattern is input from the LSI tester simulator 10 into the pseudo device 20, the device output data which corresponds to this test pattern must be simulated by the device model 23, which takes a length of time, and accordingly, there is a disadvantage that it takes an increased length of time to verify the adequacy of the test patterns.

In view of the foregoing consideration, a rapid test pattern adequacy verifier as disclosed in U.S. patent application Ser. No. 09/109,800, filed Jul. 2, 1999 has been proposed. This verifier is recited as an embodiment shown in FIG. 6. In FIG. 6, it is to be noted that parts corresponding to those shown in FIG. 5 are designated by like reference numerals as before. In this verifier, a logic simulator 22 and a device model 23 are previously driven to produce device output data in the event basis format (which is response output data from a device complying with the timing condition of a test pattern). This device output data, corresponding input data and a time of the event as referenced to the start of the test are previously stored in a dump file storage 25. A given quantity of test patterns and test cycle numbers which are applied from an LSI test simulator 10 to a pseudo device 20 as well as a given quantity of device output data and corresponding event times which are stored in the dump file storage 25 are stored in a first memory 26 and a second memory 27, respectively. The test cycle numbers and the test patterns on one hand and the event times and device output data on the other hand, which are stored in the first memory 26 and the second memory 27, respectively, are then input to a comparing and synchronizing unit 28 where device output data located at the event time which corresponds to the test cycle number is extracted for each test pattern, the device output data is converted from the event basis format into the cycle basis format in a format converter 24, and the device output data which is converted into the cycle basis format is input to the LSI tester simulator 10.

In the LSI tester simulator 10, a test pattern in the cycle basis format which is to be delivered to the format converter 21 and a pattern of expected values are produced on the basis of pattern data and timing data which are supplied from a pattern file storage 32 and a timing file storage 33, and the pattern of the expected values and the device output data which is supplied from the pseudo device 20 are compared against each other at the strobe timing. If a coincidence is reached for all of the test cycles, this test pattern is determined to be normal. In the event a non-coincidence has occurred, an address which is allocated to the test cycle in which the non-coincidence has occurred (test cycle number) is stored to be used in the verification of a faulty pattern.

In this manner, in the pseudo device 20, it is possible to obtain corresponding output data from the second memory 27 for each test pattern that is input from the LSI tester simulate 10, without causing the logic simulator 22 to operate the device model 23 to yield its output data. Thus, test patterns which are to be used in the LSI tester and which are obtained from the device logic simulation data during the device development step can be rapidly verified, without using the LSI tester or the device under test.

However, it is to be noted that in the arrangement shown in FIG. 6, it is impossible to verify whether or not all of the changes occurring in the logical states in the device output data have been compared against corresponding expected values. More specifically, when device output data which is input from the format converter 24 to the LSI tester simulator 10 transitions in a manner shown in FIG. 7A while the timing of determination against the pattern of expected values which takes place within the LSI tester simulator 10 (strobe pulse) is located as shown in FIG. 7B, it will be noted that there is an interval X between a rear portion of a test cycle No. 3 and a front portion of a test cycle No. 4 where the device output data assumes logic 0. However, because there is no strobe pulse in the interval X, the comparison against an expected value cannot take place during the interval X. In other words, it is uncertain whether or not all of changes in the logical states in the device output data have been compared against corresponding expected values.

It is an object of the invention to provide a pattern adequacy verifying apparatus and method which enable a rapid processing and capable of verifying whether or not all states have been compared against expected values each time a change occurs in the logical state of device output data.

### SUMMARY OF THE INVENTION

According to the present invention, there is provided a method of verifying the adequacy of a test pattern including the steps of deriving device output data which corresponds to a test pattern produced by a tester simulator from a result of logic simulation which takes place during a device design, applying the device output data to the tester simulator, causing the tester simulator to compare the device output data against an expected value, and determining that the test pattern corresponding to the device output data is faulty each time a non-coincidence occurs in the result of comparison;

the method further comprising the step of determining whether or not all logical states in the device output data have been compared against expected values in order to verify the adequacy of the test pattern.

An apparatus according to the invention comprises

an LSI tester simulator for producing a test pattern to be applied to a device under test and a pattern of expected values used to determine whether or not a response from the device under test is normal, both in the cycle basis format in order to test the device under test;

a format converter for converting the test pattern delivered from the LSI tester simulator into event basis format;

a first memory for storing the test pattern in the event basis format which is delivered from the format converter;

a dump file storage for storing device output data which is obtained as a result of execution by a logic simulator in the event basis format;

a second memory for storing the device output data which is read out of the dump file storage;

a comparing and synchronizing unit for extracting the device output data which is synchronized with a timing condition in the pattern data stored in the first memory from data stored in the second memory and for delivering the extracted data as device output data to the LSI tester simulator;

and timing default detecting means for reading the state of the device output data delivered from the comparing and synchronizing unit at a timing when a determination against the pattern of expected values is made in the LSI tester simulator and for detecting whether or not a timing for the determination exists each time a state in the device output data changes.

In the rapid test pattern adequacy verifier according to the invention, the determination timing default detecting means comprises, for example, logic storage means which is reset to one of logical states at the timing of determination against the expected value, for example, and upon change in the state of the device output data, inverts the stored logic to the other logical state, and error detecting means responsive to the inversion of the store logic in the logic storage means to the other logical state by detecting that the stored logic in the logic storage means is already in the other logicate state and determining the presence of an error.

The apparatus according to the invention includes as required a report formulator which stores a test cycle for which the default of the determination timing is found each time the determination timing default detecting means detects the default of the determination timing.

With the test pattern adequacy verifying method and the rapid test pattern adequacy verifier according to the invention, response output data which simulates the device model is previously provided in the dump file to permit its utilization, whereby the need to simulate the device model for each test pattern is eliminated, thereby enabling a rapid processing. In addition, a verification is made to see whether or not all of output states in the device output data have been compared against the expected values. In this manner, the adequacy of test patterns as well as the presence or absence of the default of the determination timing can be verified. As a consequence, there is provided a rapid test pattern adequacy verifier of a high reliability.

### BRIEF DESCRIPTION OF THE DRAWINGS

FIG. 1 is an illustration of features of the event basis data which are produced from CAD data;

FIG. 2 is a series of timing charts illustrating the event basis data shown in FIG. 1 in the form of waveforms;

FIG. 3 is an illustration of features of cycle basis data which is used in LSI tester;

FIG. 4 is a series of timing charts illustrating a cycle basis data shown in FIG. 3 in the form of waveforms;

FIG. 5 is a block diagram showing the functional arrangement of a conventional test pattern adequacy verifier;

FIG. 6 is a block diagram showing the functional arrangement of a test pattern adequacy verifier which is previously proposed;

FIG. 7 is a series of timing charts illustrating the relationship between device output data and determination timing and the operation of

FIG. 8 is a block diagram of a rapid test pattern adequacy verifier according to an embodiment of the invention;

FIG. 9 is a block diagram showing the functional arrangement of determination timing default detecting means shown in FIG. 8; and

FIG. 10 is a s block diagram showing the functional arrangement of a modification of the comparing and the synchronizing unit shown in FIG. 8.

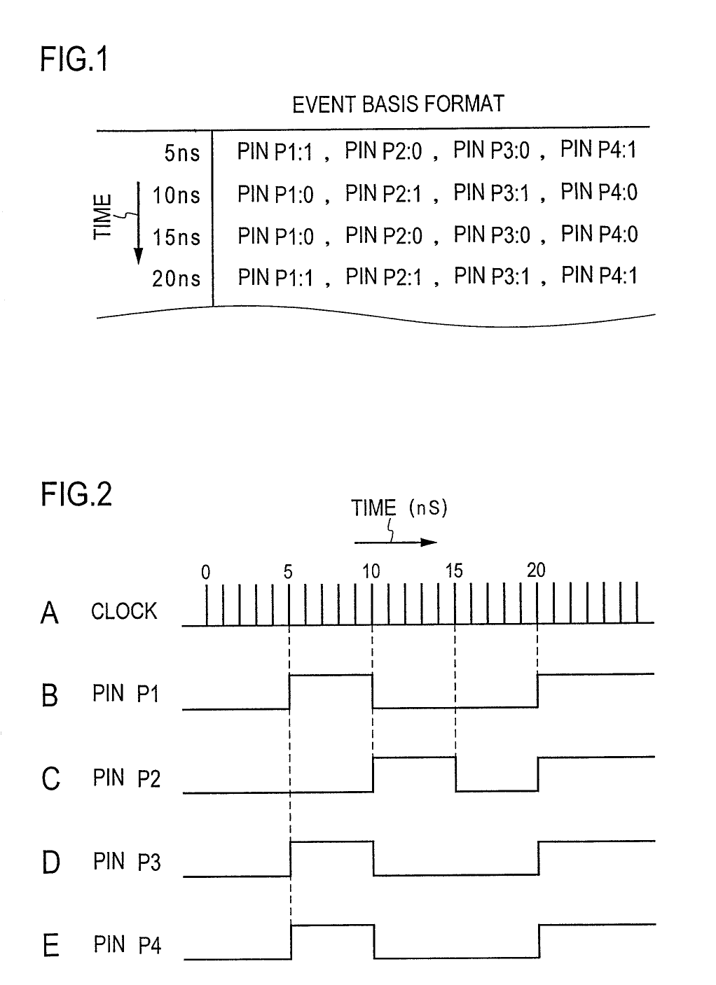

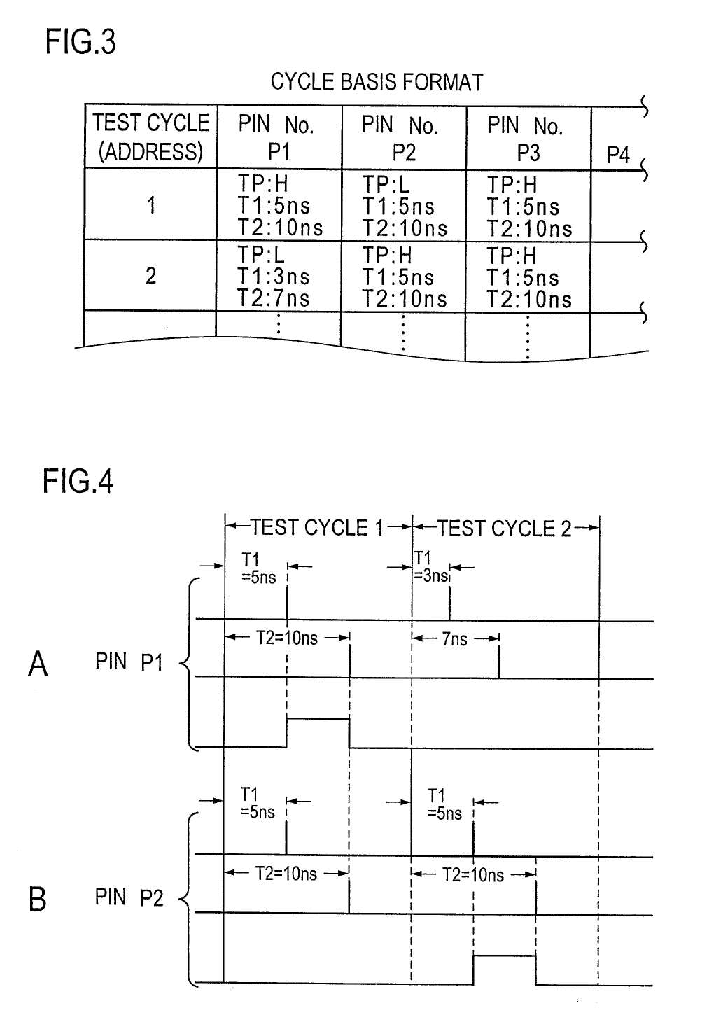

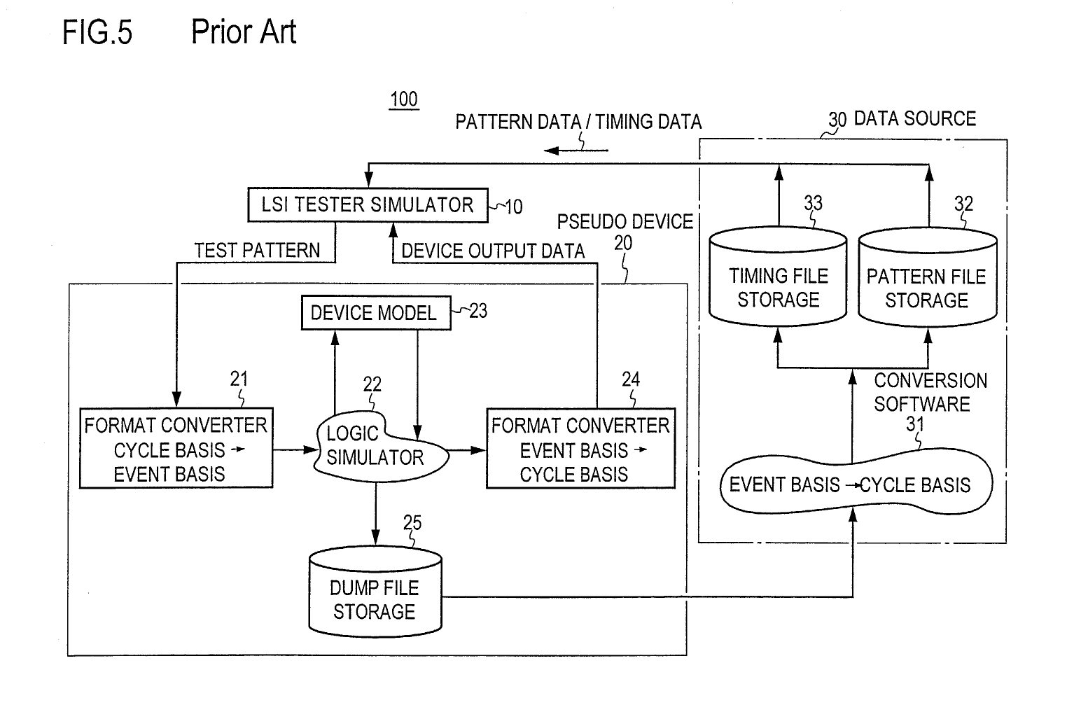

### DESCRIPTION OF PREFERRED EMBODIMENTS

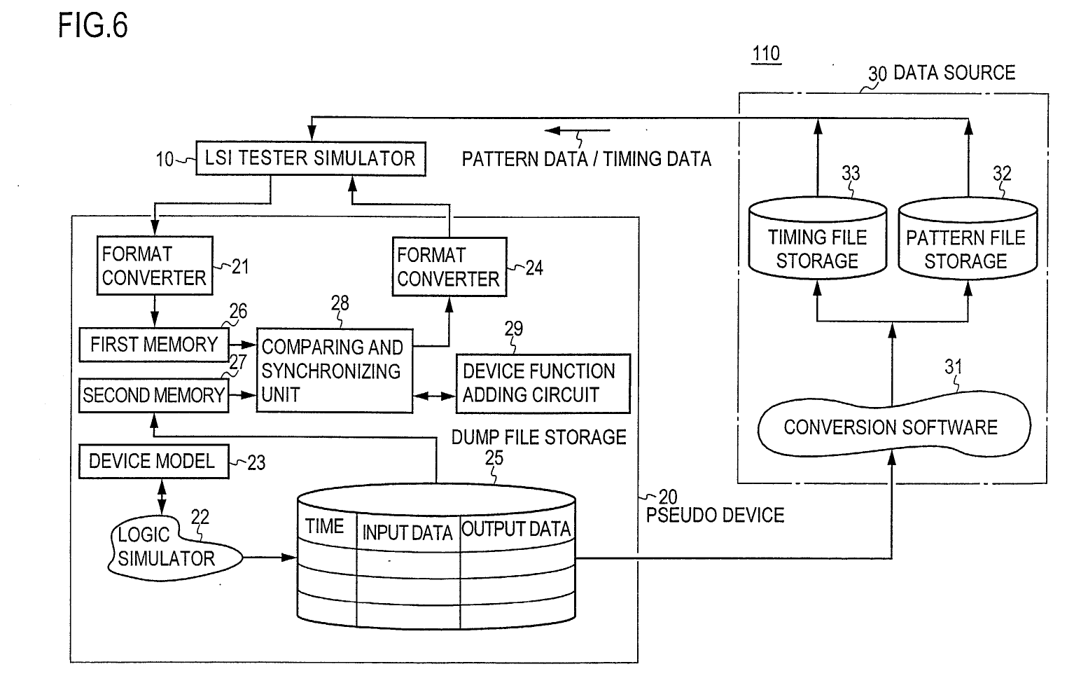

An embodiment of the invention is shown in FIG. 8 where it is to be noted that parts corresponding to those shown in FIG. 6 are designated by like numerals as used before without repeating a description of what have been mentioned before.

In accordance with the present invention, determination timing default detecting means 40 is provided in the LSI tester simulator 10 to determine whether or not all the states in the device output data have been compared against the pattern of expected values.

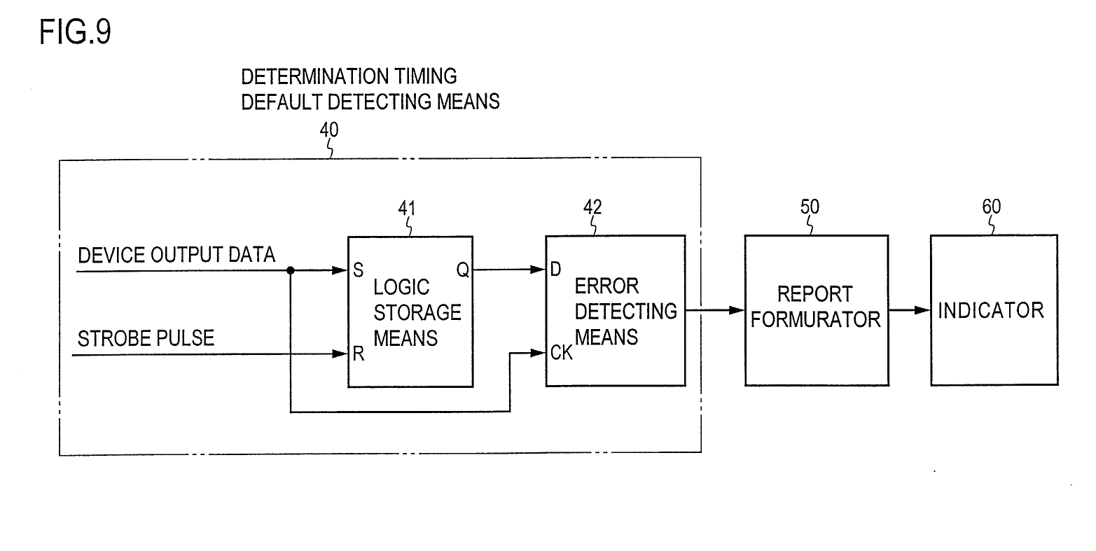

FIG. 9 shows a functional arrangement of determination timing default detecting means 40. In this example, the determination timing default detecting means 40 comprises logic storage means 41 and error detecting means 42. While the illustration of FIG. 9 assumes that the determination timing default detecting means 40 comprises a hardware, it is generally implemented in a software. The logic storage means 41 comprises a two input circuit having an input terminal S to which device output data is inup and another input terminal R to which a reset pulse is applied. What is meant by “strobe pulse” is a pulse which is used to define the timing for comparison of the device output data against the pattern of expected values which takes place within the LSI tester simulator.

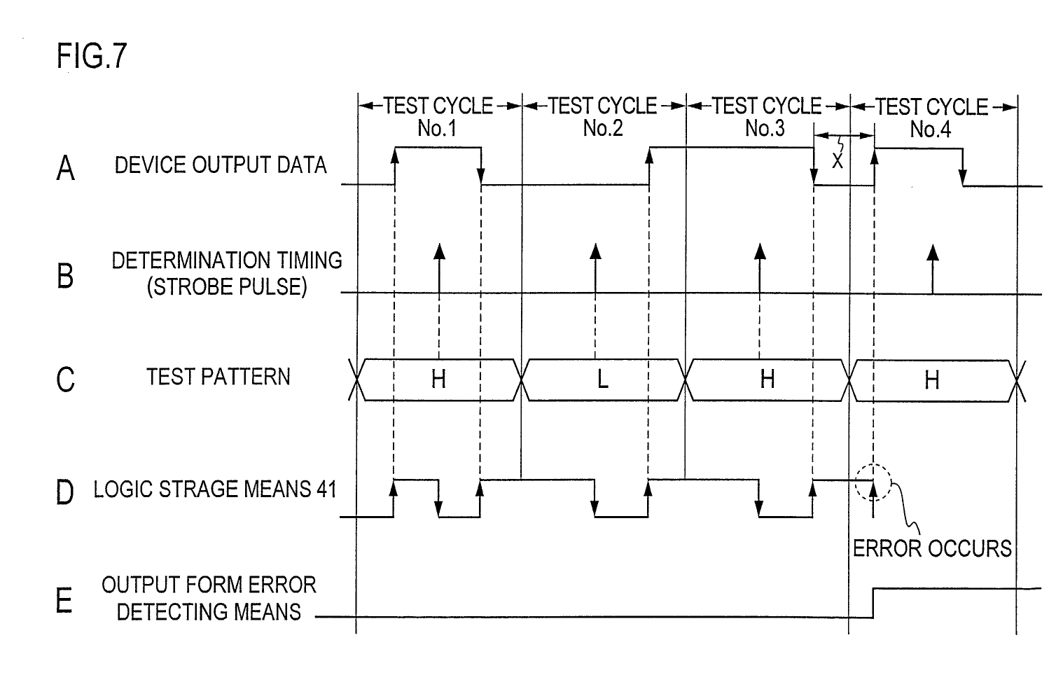

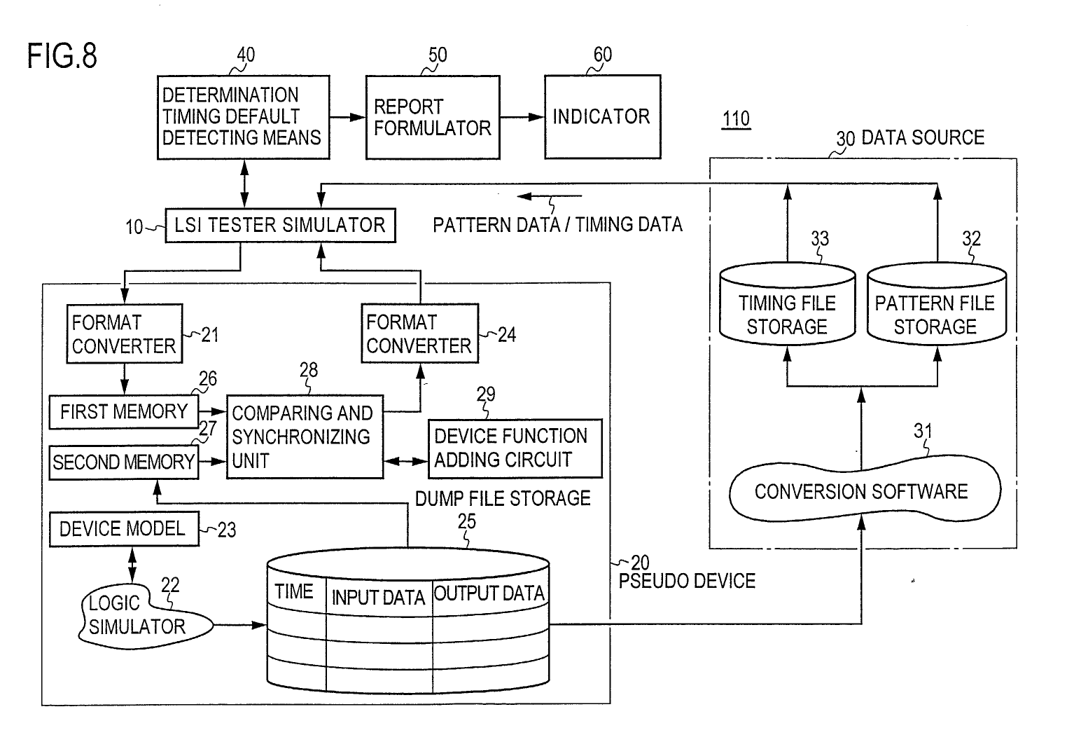

As mentioned previously, FIG. 7A shows an exemplary device output data in the form of waveforms while FIG. 7B shows exemplary strobe pulses. A verification of a test pattern comprises reading the logic value of the device output data shown in FIG. 7A at a timing when each strobe pulse is applied, comparing the read logic value against an expected value for the test pattern which is shown in FIG. 7C, and determining that the test pattern is acceptable if a coincidence is reached therebetween or that the test pattern during the present test cycle is faulty if a non-coincidence is found therebetween. In the lattern instance, the address allocated to this test cycle is stored for the convenience of verifying what caused the non-coincidence.

In addition, a determination is rendered by the determination timing default detecting means 40 in accordance with the invention whether or not all the states in the device output data have been compared against the pattern of expected values.

At this end, each time a state in the device output data which is input to an input terminal S changes from logic 0 to logic 1 or from logic 1 to logic 0, logic storage means 41 inverts the logic which is delivered to an output terminal Q to one of logical states. In this example, when the logic of the device output data is inverted, the logic at the output terminal Q of the logic storage means 41 is always inverted to logic 1. Thus, the logic at the output terminal Q of the logic storage means 41 can always be made to be logic 1 at the rising edge and the falling edge of the device output data shown in FIG. 7A, as illustrated in FIG. 7D.

By contrast, when the strobe pulse is input to the input terminal R, the logic at the output terminal Q of the logic storage means 41 is reset to logic 0. Accordingly, if the strobe pulse is applied after the inversion of the state in the device output data, it follows that the state at the output terminal Q of the logic storage means 41 is always reset to logic 0.

However, as shown in the interval between the test cycles No. 3 and No. 4 in FIG. 7A, if the strobe pulse is not applied during the interval X, during which the state in the device output data is inverted from logic 1 to logic 0, as shown, but has not then been inverted from logic 0 to logic 1, it follows that the state during the interval X cannot be compared against a corresponding expected value.

Error detecting means 42 shown in FIG. 9 is provided in order to detect such an error condition. A logic value which is delivered to the output terminal Q of the logic storage means 41 is applied to one input terminal D of the error detecting means 42 while the device output data is applied to the other input terminal CK.

Each time the device output data is inverted, the error detecting means 42 reads the logical value which is input to the input terminal D. The output terminal Q of the logic storage means 41 is rendered to be logic 1 in response to the inversion of the device output data, but there is a lag before the logic 1 is reached, and the state of logic 0 before the logic 1 is reached is read by the error detecting means 42. If the strobe pulse is applied after the inversion of the device output data to allow the device output data to be compared against the corresponding expected value, the output terminal Q of the logic storage means 41 will be reset to logic 0, and the logic 0 will be read by the error detecting means 42. However, in the event there is a default of the determination timing during the interval X in which the device output data has once been inverted, as indicated by the falling edge but before the subsequent inversion of the device output data as indicated by the rising edge, the error detecting means 42 reads logic 1, and accordingly, an output from the error detecting means 42 changes from a low level to a high level, as indicated in FIG. 7E, indicating that a determination timing corresponding to one of changed states in the device output data has been in default. In response to the decision for the presence of default from the error detecting means 42, a report formulator 50 stores an address of the test cycle during which the default of the determination timing has occurred to be subsequently used in the verification of the default of the determination timing.

The detection of the default of the determination timing takes place by providing an arrangement in which a flag is set to one state each time the logic of the device output data changes and the strobe pulse is used to set the flag to the other state, and by seeing the flag condition which immediately precedes each change in the logic of the device output data, thus determining the default of the determination timing if the flag remains in its one state.

The stored state of the report formulator 50 or the presence of the default of the determination timing is displayed on a display 60. In the embodiment shown in FIG. 8, there is provided a device function adding circuit 29 within the pseudo device 20 in the same manner as in the arrangement of FIG. 6 even though it has not been described above in connection with FIG. 6. The device function adding circuit 29 is provided to define a relationship between an input signal and an output signal which is used in the analysis of a fault of the device. The device function adding circuit 29 is programmable, thus defining a relationship between an input signal to and an output signal from the device in accordance with the content to be analyzed. For example, an actual device has a rising edge and a falling edge which does not occur instantaneously, but have slopes or involve lags. Such lag is provided by the device function adding circuit 29. In this instance, the timings of the start and the end of the device output data are displaced from each other, and the device output data which has its timing corrected in this manner is supplied to the format converter 24 as an output from the comparing and synchronizing unit 28.

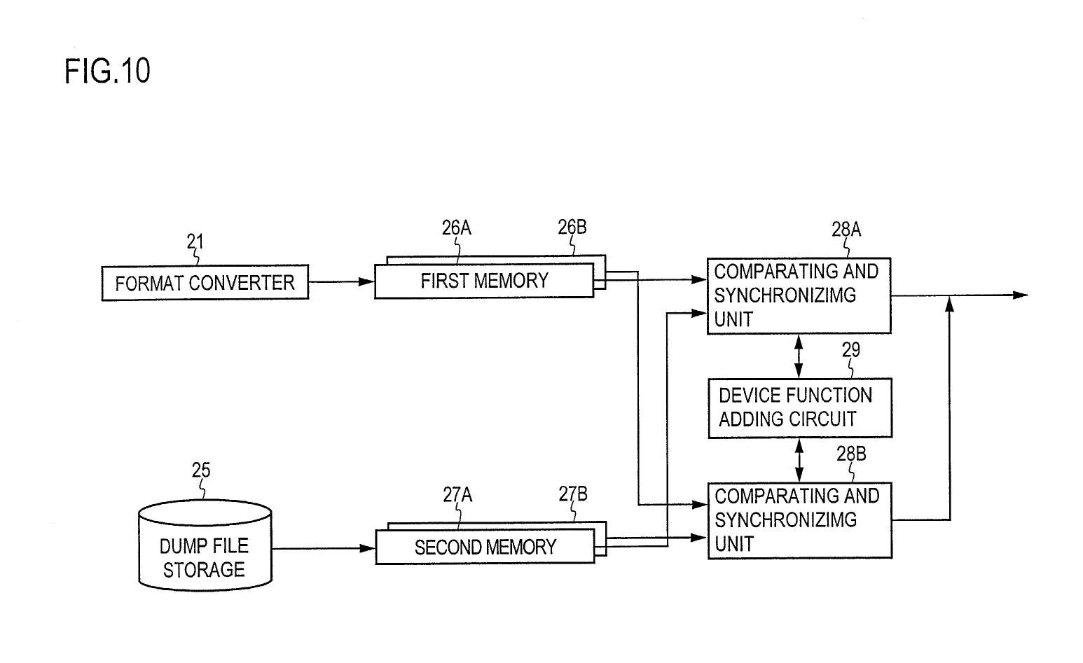

FIG. 10 shows a modification of the comparing and synchronizing unit 28 of the rapid test pattern verifier according to the invention. In this modification, there are provided two first memories 26A, 26B, two second memories 27A, 27B, two comparing and synchronizing units 28A, 28B and a device function adding circuit 29. The purpose of the two first memories 26A, 26B is to store test patterns which are converted into the event basis format by the converter 21 and their associated test cycle numbers (addresses), and each comprise a small capacity memory. The operation of the two memories 26A, 26B is interleaved in that while reading from one of the memories 26A, 26B to either comparing and synchronizing unit 28A or 28B, a given quantity of test patterns and their associated test cycle numbers which follow are input to the other memory. The second memories 27A, 27B also comprise two small capacity memories and their operations are interleaved. The interleaved operation allows a high speed operation of a small capacity memory in an inexpensive manner.

The comparing and synchronizing unit 28A operates in a similar manner as the comparing and synchronizing unit 28 shown in FIG. 8, thus comparing the time relationship between the test pattern data which is read out of the first memory 26A and the device output data which is read out of the second memory 27A for purpose of synchronization therebetween. The comparing and synchronizing unit 28A delivers the synchronized device output data, namely, the device output data which is aligned with the test pattern to the LSI tester simulator 10 through the format converter 24 as a response output of the device in response to the test pattern. The LSI tester simulator 10 compares the device output data against expected value data to verify the acceptability or the fault of the test pattern.

Similarly, the comparing and synchronizing unit 28B compares the time relationship between the test pattern data which is read out of the first memory 26B and the input data to the device under test which is read out from the second memory 27B for purpose of synchronization. The comparing and synchronizing unit 28B delivers the synchronized output data to the LSI tester simulator 10 through the format converter 24. The LSI tester simulator 10 compares the device output data against the expected value data to evaluate the test pattern.

The device function adding circuit 29 is provided between the comparing and synchronizing units 28A and 28B so that a fault simulation can be performed by correcting the timing or changing the output state at will in a similar manner as the device function adding circuit 29 shown in FIG. 6.

As discussed above, in accordance with the invention, not only the acceptability or the fault of a test pattern can be verified, but also the presence or absence of the default of a determination timing can be rapidly verified without using an LSI tester. As a consequence, the adequacy of test patterns can be verified with a high reliability.

While the present invention has been described with regard to the preferred embodiments shown by way of example, it will be apparent to those skilled in the art that various modifications, alterations, changes, and/or minor improvements of the embodiments described above can be made without departing from the spirit and the scope of the present invention. Accordingly, it should be understood that the present invention is not limited to the embodiments shown and described above, and is intended to encompass all such modifications, alterations, changes, and/or minor improvements falling within the scope of the invention defined by the appended claims.

What is claimed is:

1. A method of verifying the adequacy of test patterns, comprising the steps of
forming test patterns which are to be applied to a device under test in order to conduct a testing of the device under test and expected values used for determining whether device output data which is delivered from the device under test in response to one of the test pattern is acceptable or faulty, both in the cycle basis format;
converting the test pattern into an event basis format data;
storing the test pattern in the event basis format in a first memory;
reading device output data in the event basis format which is obtained as a result of execution of a logic simulation with respect to the device under test from a dump file storage and storing it in a second memory;
deriving device output data stored in the second memory which corresponds to the test pattern stored in the first memory;
converting the derived device output data into the cycle basis format data;
and determining whether or not all of the logical states in the converted device output data are compared against corresponding expected values.

2. A method according to claim 1, further comprising the step of
comparing the converted device output data against the expected value and if a non-coincidence is found in the result of comparison, rendering a determination that the test pattern which corresponds to this device output data is faulty.

3. A method according to claim 2 in which the step of determining whether or not the comparison against the expected value has been made comprises the step of determining whether or not a timing for the comparison against the expected value has occurred during a time interval from a change in the logic state of the device output data to a next change in the logic state.

4. A method according to claim 3 in which the determination of whether or not the timing for the comparison has occurred comprises setting a flag to one state for each change in the logic state of the converted device output data, setting the flag to the other state in response to the occurrence of the timing for the comparison, examining whether the flag is in its one state or the other state immediately before each change in the logic state of the converted device output data, and determining the absence of the timing for the comparison if the flag is in its one state.

5. A method according to claim 3 further comprising the step of
in the absence of the timing for the comparison, storing a test cycle number of the test pattern in which the timing for the comparison has not occurred in a storage.

6. A method according to claim 2 in which two of the first memories and the two of the second memories are provided and wherein while the device output data corresponding to the test pattern which is stored in one of the first memories is derived from one of the second memories, a test pattern and device output data are stored in the other of the first memories and in the other of second memories, respectively, thus allowing the two first and second memories to operate in an interleaved manner between deriving corresponding device output data and storing of the test pattern and the device output data.

7. An apparatus for rapidly verifying the adequacy of test patterns, comprising
an LSI tester simulator for forming test patterns which are to be applied to a device under test in order to conduct a testing of the device and expected values used for determining whether device output data which is delivered from the device under test in response to one of the test patterns is acceptable or faulty, both in the cycle basis format;
a cycle/event basis converter for converting a test pattern delivered from the LSI test simulator into data in the event basis format;
a first memory for storing the test pattern in the event basis format which is delivered from the cycle/event basis converter;
a dump file storage for storing device output data of the device under test which is obtained as a result of execution of a logic simulation with respect to the device under test in the event basis format;
a second memory for storing device output data which is read from the dump file storage;
a comparing and synchronizing unit for extracting the device output data which corresponds to the test pattern stored in the first memory, and for delivering the extracted data to the LSI tester simulator as device output data;
and determination timing default detecting means for detecting whether or not the determining timing for comparison of the device output data against expected values which takes place in the LSI tester simulator has existed for each change in the state of the device output data.

8. An apparatus according to claim 7 in which the determination timing default detecting means comprises logic storage means which is reset to one logic state in response to the determination timing for comparison and inverted to the other logic state in response to a change in the logic state of the device output data, and error detecting means which detects an error by detecting the other state which is already stored in the logic storage means before a change in the logic state of the device output data causes the logic state in the logic storage means to be inverted to the other logic state.

9. An apparatus according to claim 7, further comprising a report formulator for storing a test cycle number in which the default of the determination timing has occurred each time the determination timing default detecting means detects the default of the determination timing.
